(19) United States
(12) Patent Application Publication
(10) Pub. No.: US 2006/0020627 A1
(43) Pub. Date: Jan. 26, 2006

(54) Recorder with dedicated delete button and deleted files folder

(76) Inventor: Thomas Poslinski, San Diego, CA (US)

Correspondence Address: Steven L. Nichols;Rader, Fishman, & Grauer PLLC, River Park Corporate Center One, River Front Pkwy., Ste. 150, South Jordan, UT, 84095, US

(21) Appl. No.: 10/895,732

(22) Filed: Jul. 20, 2004

(51) Int. Cl. G06F 17/00

(52) U.S. Cl. 707/104.1

(57) ABSTRACT

A recorder includes a storage device for storing recorded audiovisual programs; and a user interface for controlling the recorder. The user interface includes a dedicated “delete” button for deleting data from the recorder. The recorder may also include a “deleted files” folder on the storage device and accessible through the user interface. The “deleted files” folder stores files for which a “delete” command has been made without permanently deleting the files from the storage device.

### BACKGROUND

A significant leisure and educational activity in modern society is watching broadcast television programming. Most homes include a television set for watching broadcast programming. This programming may be received by terrestrial broadcast, cable network, satellite system, computer network, etc.

Frequently, a program that a viewer wants to watch may be broadcast at a time that is inconvenient for the viewer to be watching. In other cases, a viewer may wish to watch a program repeatedly.

To address these situations, devices have been developed that allow a viewer to record broadcast programming so that the programming can be watched repeatedly or at a later time convenient for that user. Video cassette recorders (VCRs) were the first examples of such recording devices. The most recent such devices are known as Digital Video Recorders (DVRs) or Personal Video Recorders (PVRs). These devices typically include a hard-drive or other mass data storage unit that can digitally store a large volume of audiovisual programming data.

However, as the volume of programming that can be recorded and stored on a DVR or PVR increases, so does the difficulty and time required to manage that recorded programming. For example, a viewer may have to scan through a lengthy list of recorded programs to find a desired program.

### SUMMARY

A recorder includes a storage device for storing recorded audiovisual programs; and a user interface for controlling the recorder. The user interface includes a dedicated “delete” button for deleting data from the recorder. The recorder may also include a “deleted files” folder on the storage device and accessible through the user interface. The “deleted files” folder stores files for which a “delete” command has been made without permanently deleting the files from the storage device.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates an exemplary system according to the principles described herein in which a recorded program can be easily deleted with a dedicated button on a remote control unit.

FIGS. 2 and 3 illustrate operation of the system pictured in FIG. 1.

FIG. 4 is a flowchart illustrating a method of operating the system illustrated in FIG. 1.

FIG. 5 is another flowchart illustrating a second method of operating the system of FIG. 1.

FIG. 6 illustrates an exemplary system according to principles described herein in which deleted programs are kept in a “deleted files” folder, at least temporarily, so that a user who needs or wants the program can still recover it to the system.

FIG. 7 is a flowchart illustrating a method of operating the system of FIG. 6.

Throughout the drawings, identical reference numbers designate similar, but not necessarily identical, elements.

### DETAILED DESCRIPTION

The present specification describes a method and system that allows a user to very easily delete a program recorded and stored on a recorder, such as a DVR or PVR. Additionally, the present specification describes a method and system that allow an inadvertently deleted program to be recovered before it is permanently deleted.

As used herein, and in the appended claims, the term “recorder” shall refer broadly to any device that can record audiovisual programming, for example, DVRs, PVRs, laptops, computers, servers, etc. The term “program” or “programming” shall refer to an audio, audiovisual or video program.

As noted above, the sheer volume of programming that can be recorded and stored on a DVR, PVR or similar recorder can make it difficult to manage and use that recorded programming. For example, when a viewer desires to replay a particular recorded program, the viewer will typically have to scan through a lengthy list of recorded programs to find the program desired. This can be time-consuming.

Programs, once stored, however, can be deleted to ease the burden of managing such a lengthy list of recorded programs. But, the process to delete a recorded program is typically cumbersome and requires a number of steps to actually delete the program.

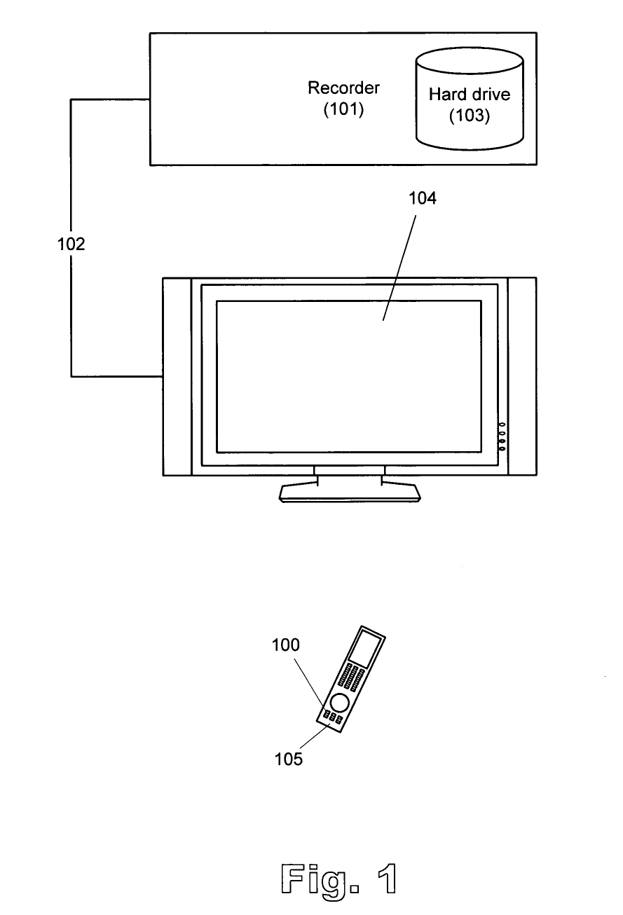

To address this situation, FIG. 1 illustrates an exemplary system according to the principles described herein in which a recorded program can be easily deleted with a dedicated button on a remote control unit. As shown in FIG. 1, the system includes a television set or video monitor (104) for displaying broadcast or recorded programming and a recorder (101), such as a DVR or PVR, for recording programs. The monitor (104) is connected (102) to the recorder (101). However, in some embodiments, the monitor (104) and recorder (101) may be integrated into a single unit.

The recorder (101) includes a hard drive or hard disk drive (103) or other mass data storage device. Programming is recorded and stored on the hard drive (103). A viewer can control the recorder (101) to selectively record programming or to replay recorded programming on the video monitor (104). A remote control unit (105) is used to control either or both of the recorder (101) and the video monitor (104).

According to the present specification, the remote control unit (105) includes a dedicated “delete” button (100). This button (100) can be used, as will be described further herein, to rapidly delete a program, setting or other entry stored on the memory unit, e.g., the hard drive (103), of the recorder (101). The exact command executed by the recorder (101) in response to actuation of the delete button (100) on the remote control unit (105) will vary depending on what is being displayed on the monitor (104) when the button (100) is pressed, e.g., what portion of a user interface is then active.

For example, if the user is looking through a directory or listing of programs stored on the memory unit (103) of the recorder (101), and the delete button (100) is pressed, the recorder (101) will interpret this as a command to delete the program then indicated in the list of programs by a cursor controlled with the remote control unit (105). Alternatively, if the recorder (101) is replaying a recorded program on the video monitor (104), and the delete button (100) is pressed, the recorder (101) will interpret this as a command to delete the program then being replayed.

In either case, the recorder (101) may prompt the viewer to confirm the delete command before deleting the indicated program. However, in some embodiments, the viewer may not be asked to confirm a delete command. The user can confirm the delete command by, for example, again pressing the dedicated “delete” button (100) on the remote control unit (105). Additionally or alternatively, other buttons on the remote control unit (105) can be used to confirm or cancel the delete command.

It may be the case, that once a program is deleted, it is irretrievable. Therefore, it may be desirable to obtain viewer confirmation before deleting an indicated file. In some embodiments, the viewer will be able to program the recorder (101) to either request or not request confirmation of a delete command given via the delete button (100) of the remote control unit (105).

The “delete” button (100) can also be used to instantly remove or delete any other data stored on the recorder (101). For example, a setting to record a program or programs at a particular date and time can be rapidly deleted from the recorder (101) by indicating the setting and pressing the “delete” button (100). Thus, the “delete” button (100) significantly assists a viewer in operating the recorder (101) and managing the content stored on the recorder (101).

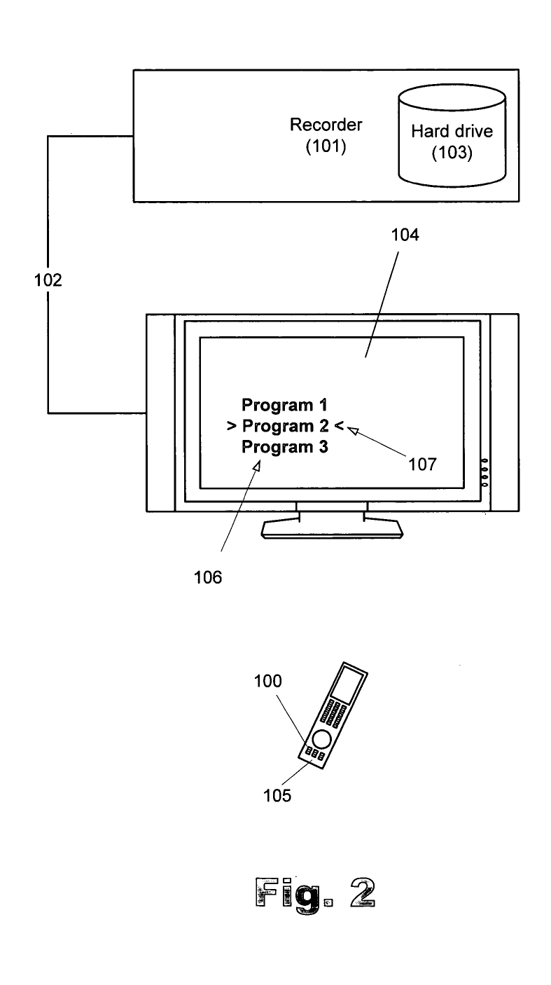

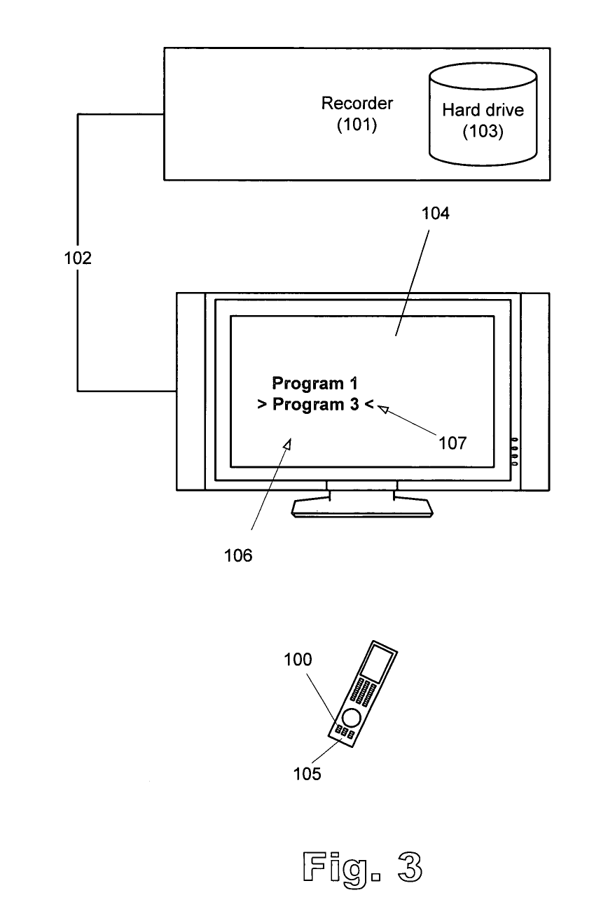

FIGS. 2 and 3 illustrate operation of the system pictured in FIG. 1. The recorder (101), under control of the remote control unit (105), outputs a user interface that is displayed on the monitor (104). As shown in FIG. 2, the recorder (101) is outputting a list (106) of programs that have been recorded and stored on the hard drive (103) of the recorder (101).

A cursor (107) can be moved within the user interface and the list (106) of recorded programs by a viewer. The cursor (107) is controlled with the remote control device (105).

In the example of FIG. 2, the viewer wishes to delete Program 2 from the recorder (101), i.e., the hard drive (103). Thus, the viewer, using the remote control unit (105) moves the cursor (107) through the list of recorded programs until Program 2 is indicated, as is shown in FIG. 2.

The user then actuates or presses the dedicated “delete” button (100) on the remote control unit (105). In response, Program 2 is deleted from the hard drive (103) without any further action being required by the viewer.

FIG. 3 illustrates the system after Program 2 has been deleted in response to use of the dedicated “delete” button (100) on the remote control unit (105). As shown in FIG. 3, the listing for Program 2 no longer appears in the list (106) of the user interface, indicating that Program 2 is not longer available for replay but has been deleted.

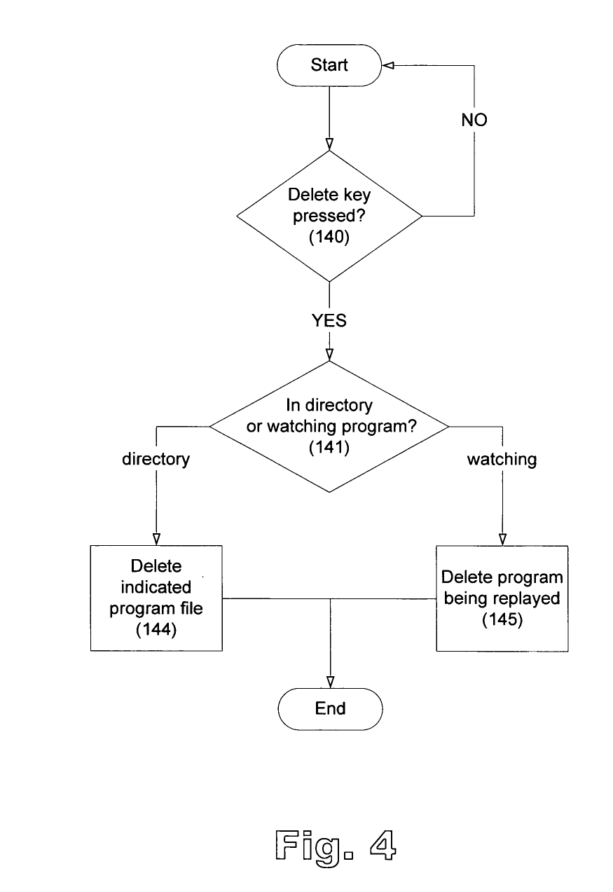

FIG. 4 is a flowchart illustrating a method of operating the system illustrated in FIG. 1. As shown in FIG. 4, the system waits for the dedicated “delete” button to be pressed on the remote control unit. Alternatively or additionally, a dedicated “delete” button may be placed on the recorder itself. Such a “delete” button would operate in the same manner as the “delete” button on a remote control unit as described herein.

Once the dedicated “delete” button has been pressed (determination 140), the response of the system depends on what the system is doing at that moment or what portion of a user interface is then being displayed. For example, the user interface may be displaying a directory or listing of recorded programming as illustrated in FIGS. 2 and 3. Alternatively, the system may be in the process of replaying a particular recorded program when the dedicated “delete” button is pressed.

If the user interface is displaying a directory of recorded programming (determination 141), and the dedicated “delete” button is pressed (determination 140), the program indicated or highlighted in the directory of recorded programming when the “delete” button is pressed is deleted (step 144). This is the scenario illustrated in FIGS. 2 and 3. Alternatively, if the system is in the process of replaying a recorded program which the user is watching (determination 141), and the dedicated “delete” button is pressed (determination 140), the program being watched when the “delete” button is pressed is deleted (step 145).

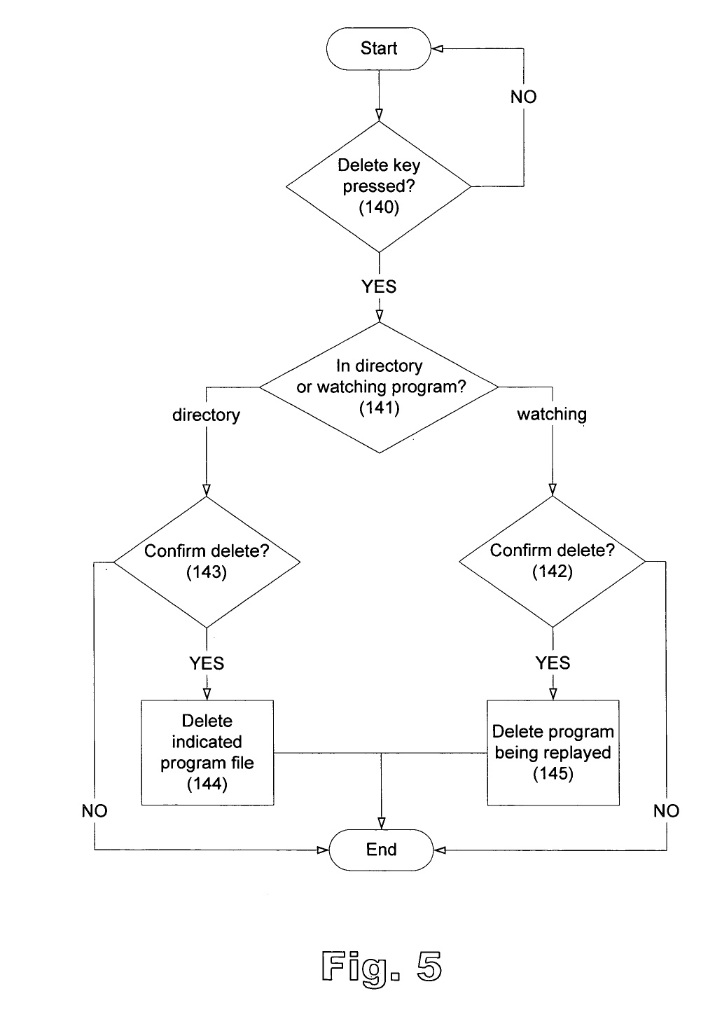

FIG. 5 is another flowchart illustrating a second method of operating the system of FIG. 1. In many respects, the method of FIG. 5 is similar to that of FIG. 4. As shown in FIG. 5, the system waits for the dedicated “delete” button to be pressed on the remote control unit. Alternatively or additionally, a dedicated “delete” button may be placed on the recorder itself. Such a “delete” button would operate in the same manner as the “delete” button on a remote control unit as described herein.

Once the dedicated “delete” button has been pressed (determination 140), the response of the system depends on what the system is doing at that moment or what portion of a user interface is then being displayed. For example, if the user interface is displaying a directory of recorded programming (determination 141), and the dedicated “delete” button is pressed (determination 140), the system interprets this as a command to delete the program indicated or highlighted in the directory of recorded programming when the “delete” button is pressed.

However, before that program is actually deleted, the system prompts the user to confirm the command to delete that program (determination 143). If the delete command is confirmed, the indicated program is deleted (step 144) without further action from the viewer. If the delete command is cancelled, the program is not deleted. The system then returns to waiting for a delete command.

Alternatively, if the system is in the process of replaying a recorded program which the user is watching (determination 141), and the dedicated “delete” button is pressed (determination 140), the system interprets this as a command to delete the program being watched when the “delete” button is pressed.

However, before that program is actually deleted, the system prompts the user to confirm the command to delete that program (determination 142). If the delete command is confirmed, the program being replayed is deleted (step 145) without further action from the viewer. If the delete command is cancelled, the program is not deleted. The system then returns to waiting for a delete command.

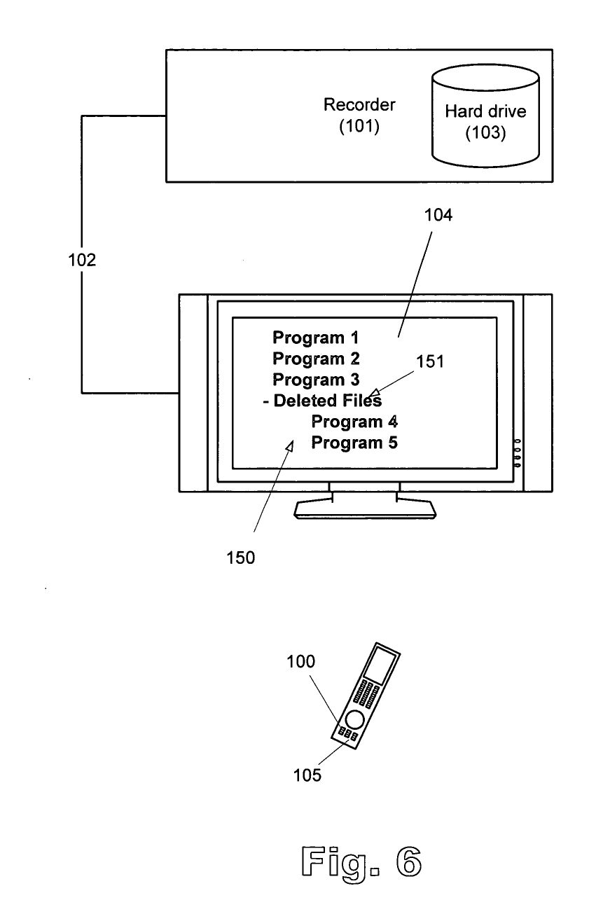

FIG. 6 illustrates an exemplary system according to principles described herein in which deleted programs are kept in a “deleted files” folder, at least temporarily, so that a user who needs or wants the program can still recover it to the system. As noted above, conventional recorders irrevocably delete a program in response to a delete command. Thus, it can be important to have the user confirm a delete command before the program is irrevocably deleted.

To address this situation, some embodiments described herein include a “deleted files” folder on the recorder (101), e.g., on the hard drive (103) of the recorder (101). When a delete command is issued for a program, the recording of that program is moved to the “deleted files” folder (151).

In these embodiments, the viewer may still be asked to confirm the “delete” command. If the viewer is asked to confirm the “delete” command, the recording of the program is only moved to the “deleted files” folder if the viewer confirms the “delete” command.

As shown in FIG. 6, the user interface of the recorder (101) as displayed on a video monitor (104) will include a listing (150) of the programs (e.g., Program 1, Program 2, etc.) that have been recorded and stored on the hard drive (103) of the recorder (101). This listing (150) may include a number of folders into which recorded programs are organized. For example, episodes of a particular series may be stored in one folder. Programs belonging to a particular genre or recorded on a particular date may be stored in date-specific or genre-specific folders.

Additionally, the listing (150) may include a “deleted files” folder (151). The files listed in the “deleted files” folder (151), e.g., Program 4, Program 5, etc., are files for programs that have been deleted by the viewer. When a delete command is received, and in some cases, confirmed, the specified file is moved to the “deleted files” folder (151).

Additionally, some portion of the programming on the recorder (101), such as a preference engine, may delete files automatically without the knowledge of the viewer. A preference engine includes a profile or data set that specifies types or indicators of programs that a viewer prefers. Such a preference engine may, occasionally, delete files that have been recorded that do not meet viewer preference parameters. Such files are then moved into the “deleted files” folder (151).

As shown in FIG. 6, the viewer can operate the user interface of the recorder (101), using, for example, the remote control unit (105), so as to access the “deleted files” folder (151). The viewer can then see a listing of the deleted files retained in the “deleted files” folder (151) as shown in FIG. 6.

If one of the programs in the “deleted files” folder (151) was deleted erroneously, the viewer can locate that program in the “deleted files” folder (151) and restore the program to some other portion of the listing (150). Thus, the program file can be effectively un-deleted. The “restore command” can be issued using, for example, the remote control unit (105), a user interface on the recorder (101) or some other means.

Meta-data such as title, description, date recorded and restore parameters and location, are stored with the file in the “deleted files” folder (151). When the user access the file in the “deleted files” folder (151), at least some of this data, such a title, description, etc., can be viewed. When a restore command is issued, the meta-data is read, including the restore parameters. The folder where the file is to be restored is then checked. If the folder exists, a move command is issued to the hard drive (103) file system. The file is then moved from the “deleted files” folder (151) to the folder specified in the restore parameters. If the folder specified in the restore parameters does not exist, the file can be moved and restored to the main level or folder of the hierarchy (150). Once the file is moved, it is no longer listed in the “deleted files” folder (151) and can be accessed for replay or other operations.

This whole process helps the viewer manage the programs stored on the recorder (101). Unwanted programs can be deleted either by the viewer or a preference engine. While, if any mistake is made and a program deleted unintentionally or erroneously, that program can be retrieved from the “deleted files” folder (151) and restored for storage on the recorder (101) and subsequent replay.

However, to prevent the “deleted files” folder (151) from becoming too large and to prevent the unnecessary use of the hard drive (103) to store “deleted” files, there is a mechanism for permanently deleting files from the “deleted files” folder (151). Files deleted from the “deleted files” folder (151) are permanently deleted, meaning that such files are no longer stored on, and taking up space on, the hard drive (103) and cannot be recovered or restored.

The “deleted files” folder (151) can be shown in a hierarchy or tree of files and folders as shown in FIG. 6. Alternatively, the user interface of the recorder (101) may represent the “deleted files” folder graphically with an icon of a trash can, waste basket or the like.

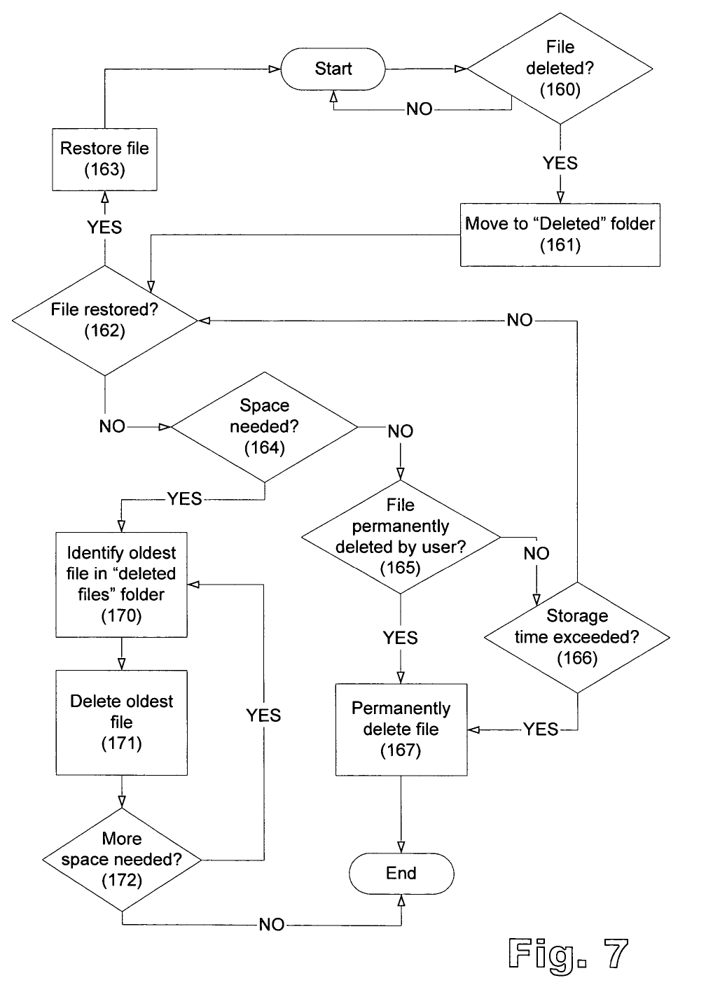

FIG. 7 is a flowchart illustrating a method of operating the system of FIG. 6 including the various mechanisms for permanently deleting files from the “deleted files” folder (151, FIG. 6). As shown in FIG. 7, the system waits for a delete command, which may come from a viewer or from some other system agent such as a preference engine. When a delete command is issued for a file (determination 160), the file is moved to the “deleted files” folder (step 161).

As described above, while the file is in the “deleted files” folder, it may be accessed and restored. If the deleted file is restored (determination 162), the file is moved out of the “deleted files” folder (step 163) and is then, once again, accessible for playback or other operations.

If the file is not restored (determination 162), the file will not remain indefinitely in the “deleted files” folder. The file may be permanently deleted in response to one of several occurrences.

In some cases, the viewer may attempt to record additional programs for which there is insufficient space on the recorder's storage device, e.g., hard drive (103, FIG. 1). If the recorder needs additional storage space to execute a record command (determination 164), one or more program files can be deleted from the “deleted files” folder to make room for the desired recording.

First, the recorder will determine which is the oldest file in the “deleted files” folder (step 170). This determination may be based on which file in the “deleted files” folder was recorded first or which file was first moved to the “deleted files” folder. When the oldest file has been identified, it is deleted from the “deleted files” folder (step 171), i.e., permanently removed from the storage device of the recorder.

The recorder then checks to see if there is now sufficient space for the program the viewer is trying to record (determination 172). If more space is needed, the recorder again identifies (step 170) and deletes (step 171) the oldest file in the “deleted files” folder. This continues until there is sufficient space to record the program the viewer wishes to record. That program is then recorded and stored on, for example, the hard drive of the recorder.

Programs may also be removed from the “deleted files” folder, i.e., permanently deleted, under the control of the viewer. While accessing the “deleted files” folder, the viewer may, for example, issue another delete command for an indicated or highlighted file (determination 165). The recorder will interpret this as a command to permanently delete the file because the file is already in the “deleted files” folder. Consequently, the indicated file is the permanently deleted from the storage device of the recorder (step 167).

Finally, files in the “deleted files” folder (151) may be automatically deleted permanently when a specified storage time has elapsed. For example, if the file has been in the “deleted files” folder for one week or a number of days (determination 166), the recorded may then automatically delete the file by permanently removing it from the storage device of the recorder (step 167).

The recorder may allow the viewer to set the storage time limit after which files stored in the “deleted files” folder are permanently deleted. The viewer can then specify how long files are to be kept in the “deleted files” folder before being permanently deleted. The storage time limit may be measured from the time a file is moved into the “deleted files” folder.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A recorder comprising:
a storage device for storing recorded audiovisual programs; and
a user interface for controlling said recorder,
wherein said user interface comprises a dedicated “delete” button for deleting data from said recorder.

2. The recorder of claim 1, wherein said storage device comprises a hard drive.

3. The recorder of claim 1, wherein said recorder comprises a Personal Video Recorder or Digital Video Recorder.

4. The recorder of claim 1, wherein said user interface comprises a remote control unit that communicates wirelessly with said recorder and said “delete” button is disposed on said remote control unit.

5. The recorder of claim 1, further comprising a connection for connecting to a video monitor on which said recorder displays a portion of said user interface including a listing of programs stored on said storage device.

6. The recorder of claim 1, wherein, if said user interface is displaying a listing of stored programs, said recorder deletes an indicated program in response to actuation of said “delete” button.

7. The recorder of claim 1, wherein, if said recorder is replaying a recorded program, said recorder deletes the program being replayed in response to actuation of said “delete” button.

8. The recorder of claim 6, wherein said recorder prompts a viewer to confirm a command to delete said indicated program.

9. The recorder of claim 7, wherein said recorder prompts a viewer to confirm a command to delete said replaying program.

10. The recorder of claim 1, wherein said recorder moves an indicated program to a “deleted files” folder in response to actuation of said “delete” button.

11. The recorder of claim 10, wherein said user interface enables a viewer to access said “deleted files” folder and restore deleted files.

12. The recorder of claim 10, wherein said recorder permanently deletes files from said “deleted files” folder to make room for a program to be recorded.

13. The recorder of claim 10, wherein said recorder permanently deletes files from said “deleted files” in response to a delete command from a viewer.

14. The recorder of claim 10, wherein said recorder permanently deletes files from said “deleted files” folder after a specified storage time limit has elapsed.

15. A recorder comprising:
a storage device for storing recorded audiovisual programs;
a user interface for controlling said recorder; and
a “deleted files” folder on said storage device and accessible through said user interface for storing files for which a “delete” command has been made without permanently deleting said files from said storage device.

16. The recorder of claim 15, wherein said user interface enables a viewer to access said “deleted files” folder and restore deleted files.

17. The recorder of claim 15, wherein said recorder permanently deletes files from said “deleted files” folder to make room for a program to be recorded.

18. The recorder of claim 15, wherein said recorder permanently deletes files from said “deleted files” in response to a delete command from a viewer.

19. The recorder of claim 15, wherein said recorder permanently deletes files from said “deleted files” folder after a specified storage time limit has elapsed.

20. The recorder of claim 15, wherein said storage device comprises a hard drive.

21. The recorder of claim 15, wherein said recorder comprises a Personal Video Recorder or Digital Video Recorder.

22. The recorder of claim 15, wherein said recorder moves an indicated program to a “deleted files” folder in response to actuation of a dedicated “delete” button of said user interface.

23. The recorder of claim 22, wherein said user interface comprises a remote control unit that communicates wirelessly with said recorder and said “delete” button is disposed on said remote control unit.

24. The recorder of claim 15, further comprising a connection for connecting to a video monitor on which said recorder displays a portion of said user interface including a listing of programs stored on said storage device.

25. The recorder of claim 22, wherein, if said user interface is displaying a listing of stored programs, said recorder deletes an indicated program in response to actuation of said dedicated “delete” button.

26. The recorder of claim 22, wherein, if said recorder is replaying a recorded program, said recorder deletes the program being replayed in response to actuation of said “delete” button.

27. A method of operating a recorder comprising pressing a dedicated “delete” button of a user interface of said recorder to delete audiovisual programs or other data from a storage device of said recorder.

28. The method of claim 27, further comprising automatically deleting an indicated program in response to actuation of said “delete” button without requiring further user action.

29. The method of claim 27, further comprising automatically deleting selected data from said storage device in response to actuation of said “delete” button without requiring further user action.

30. The method of claim 29, wherein said selected data comprises a setting to record an audiovisual program at a particular date and time.

31. The method of claim 27, wherein said storage device comprises a hard drive.

32. The method of claim 27, wherein said user interface comprises a remote control unit that communicates wirelessly with said recorder and said “delete” button is disposed on said remote control unit, wherein pressing said dedicated “delete” button comprises actuating said “delete” button in said remote control unit.

33. The method of claim 27, further comprising displaying, on a video monitor connected to said recorder, a portion of said user interface including a listing of programs stored on said storage device.

34. The method of claim 33, wherein, if said user interface is displaying a listing of stored programs, said method further comprises deleting an indicated program in response to actuation of said “delete” button.

35. The method of claim 27, wherein, if said recorder is replaying a recorded program, said method further comprises deleting the program being replayed in response to actuation of said “delete” button.

36. The method of claim 34, further comprising prompting a viewer to confirm a command to delete said indicated program.

37. The method of claim 35, further comprising prompting a viewer to confirm a command to delete said replaying program.

38. The method of claim 27, further comprising moving an indicated program to a “deleted files” folder in response to actuation of said “delete” button.

39. The method of claim 38, further comprising allowing a viewer to access said “deleted files” folder and restore deleted files using said user interface.

40. The method of claim 38, further comprising permanently deleting files from said “deleted files” folder to make room for a program to be recorded.

41. The method of claim 38, further comprising permanently deleting files from said “deleted files” in response to a further delete command from a viewer.

42. The method of claim 38, further comprising permanently deleting files from said “deleted files” folder after a specified storage time limit has elapsed.

43. A method of operating a recorder comprising moving a file comprising an audiovisual program to a “deleted files” folder on a storage device of said recorder when a “delete” command has been made for said file without permanently deleting said file from said storage device.

44. The method of claim 43, further comprising providing a viewer to access said “deleted files” folder through said user interface.

45. The method of claim 44, further comprising providing a viewer an option to restore a deleted file by moving said deleted file out of said “deleted files” folder.

46. The method of claim 43, further comprising permanently deleting files from said “deleted files” folder to make room for a program to be recorded.

47. The method of claim 43, further comprising permanently deleting files from said “deleted files” in response to a delete command from a viewer.

48. The method of claim 43, further comprising permanently deleting files from said “deleted files” folder after a specified storage time limit has elapsed.

49. The method of claim 43, further comprising moving an indicated program to said “deleted files” folder in response to actuation of a dedicated “delete” button.

50. The method of claim 43, further comprising connecting said recorder to a video monitor and displaying a listing of programs stored on said storage device, including files in said “deleted files” folder.

51. The method of claim 43, wherein, if said recorder is displaying a listing of stored programs, said method comprises moving an indicated program to said “deleted files” folder in response to actuation of a dedicated “delete” button.

52. The method of claim 43, wherein, if said recorder is replaying a recorded program, said method comprises moving an indicated program to said “deleted files” folder in response to actuation of a dedicated “delete” button.

53. A recorder for audiovisual programming comprising:
means for storing data and files comprising audiovisual programs;
means for deleting data or files in response to a viewer actuating a dedicated “delete” button of a user interface of said recorder.

54. A recorder for audiovisual programming comprising:
means for storing files comprising audiovisual programs; and
means for retaining a file on said recorder after a “delete” command has been made for said file without permanently deleting said file from said means for storing files.
